(19) United States
(12) Patent Application Publication
(10) Pub. No.: US 2015/0110580 A1
(43) Pub. Date: Apr. 23, 2015

(54) DEVICE FOR FORMING BOOK BLOCKS

(71) Applicant: manroland web systems GmbH, Augsburg (DE)

(72) Inventors: Peter KNAUER, Muenster/Lech (DE); Robert Mayr, Neusaess (DE); Manfred Batke, Augsburg (DE); Dominik Schmitt, Augsburg (DE)

(73) Assignee: manroland web systems GmbH, Augsburg (DE)

(21) Appl. No.: 14/515,963

(22) Filed: Oct. 16, 2014

(30) Foreign Application Priority Data
Oct. 17, 2013 (DE) 10 2013 017 223.3

(51) Int. Cl. B42C 1/12

(52) U.S. Cl. CPC B42C 1/12
USPC 412/35

(57) ABSTRACT

A device for forming book blocks is disclosed. The device includes a first conveying device which accepts signatures printed in a printing press located upstream. The device further includes at least one signature switch assigned to the first conveying device, multiple second conveying devices, and multiple book block formers, where each second conveying device is assigned a book block former and where each book block former can be supplied with signatures belonging to the same book block dependent on a position of the or each signature switch. The device further includes multiple placers, where each book block former is assigned a placer which accepts the book blocks formed in the respective book block former, and a third conveying device, onto which the book blocks can be placed with the help of the placers and which feeds the book blocks to a delivery device.

This application claims the priority of German Patent Document No. DE 10 2013 017 223.3, filed Oct. 17, 2013, the disclosure of which is expressly incorporated by reference herein.

### BACKGROUND AND SUMMARY OF THE INVENTION

The invention relates to a device for forming book blocks out of signatures printed in a printing press located upstream or signatures printed beforehand unwound in an unwinding device located upstream.

From practice, printing presses designed as reel-fed printing presses are already known in which a web-like substrate is printed, wherein the web-like substrate can be folded in a folder and separated into signatures. Furthermore, printing presses are already known from practice in which separated signatures can be combined into a print copy for example through stitching.

For the variable printing in small printing runs, printing presses designed as digital printing presses are increasingly employed. Here it is important to separate the substrate printed on a digital printing press into signatures and variably combine the separate signatures into so-called book blocks. Up to now, no devices are known with which it is possible to combine signatures that have been profitably printed, separated and if appropriate folded in a small run into book blocks.

Starting out from this, the object of the present invention is based on creating a new type of device for forming book blocks.

The device for forming book blocks according to the invention comprises: a first conveying device, which in the printing press located upstream accepts printed signatures; at least one signature switch assigned to the first conveying device; multiple second conveying devices, wherein each of the signatures conveyed by the first conveying device can each be fed to one of the multiple second conveying devices dependent on the position of the or each signature switch; multiple book block formers, wherein each second conveying device is assigned a book block former each, wherein dependent on the position of the or each signature switch each book block former can be supplied with the signatures belonging to the same book block via the second conveying device interacting with the respective book block former; multiple placers, wherein each book block former is assigned a placer each, which following the release through the respective book block former accepts the book blocks formed in the respective book block former from the same; a third conveying device, on which the book blocks can be placed with the help of the placers and which feeds the book blocks to a delivery device. The device according to the invention allows a profitable forming of book blocks of printed, separated and if appropriate folded signatures in a small run.

According to an advantageous further development of the invention, the first conveying device runs horizontally and transports the printed, separated and if appropriate folded signatures in the horizontal direction, wherein the third conveying device runs horizontally below the first conveying device and transports the book blocks in the horizontal direction, and wherein the second conveying devices in each case run obliquely from the top down between the first conveying device and the book block formers. Preferentially, the second conveying devices are designed in such a manner that in the same the signatures can be shingled up before being introduced into the respective book block former. This arrangement of the different conveying devices allows a particularly advantageous formation of book blocks.

According to an advantageous further development of the invention, each book block former comprises a stop, which can be transferred between a first position, in which on the same the signatures belonging to a book block can be collected and a second position, in which the same releases a book block formed in the book block former, wherein each book block former is assigned a book block conveyor which in the second position of the stop of the book block former feeds the book block formed in the same starting out from the book block former to the placer interacting with the same. Preferentially, each book block former comprises a pressing device, with the help of which each book block formed in the respective book block former can be compressed and thus compacted at least in sections. The interaction of the book block formers with the book block conveyors allows an effective forming of book blocks.

According to an advantageous further development of the invention, each placer can be transferred between a first position, in which the same can be supplied with a book block starting out from the book block former interacting with the same and a second position, in which a book block can be placed onto the third conveying device by the same. Preferentially, the stop of the respective book block former can be exclusively transferred from the first position into the second position in particular when the placer interacting with the respective book block former is transferred into the first position. This configuration of the placers makes it possible to reliably transfer the book block formed in the book block formers to the third conveying device.

Preferred further developments of the invention are obtained from the following description. An exemplary embodiment of the invention is explained in more detail with the help of the drawings without being restricted to this.

### BRIEF DESCRIPTION OF THE DRAWINGS

FIG. 1 is a schematic representation of a plant comprising a digital reel-fed printing press, a folding device and a device for forming book blocks according to the invention;

FIG. 2 illustrates the device according to the invention for forming book blocks in sole representation;

FIG. 3 is a detail of an alternative device for forming book blocks;

FIG. 4 is a detail of a further alternative device for forming book blocks; and

FIG. 5 is a detail of a further alternative device for forming book blocks.

### DETAILED DESCRIPTION OF THE DRAWINGS

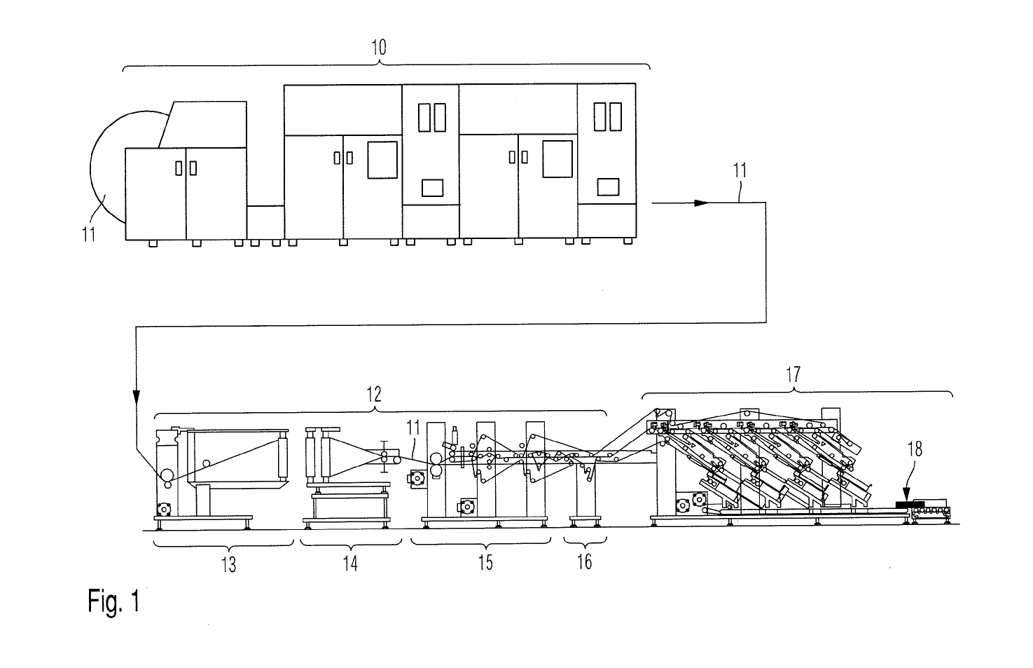

FIG. 1 schematically shows a printing plant with a reel-fed printing press 10 designed as a digital printing press, in which a web-like substrate 11 can be variably printed with different printing contents. The web-like substrate printed in the reel-fed printing press 10 designed as a digital printing press can be fed to a folding device 12, wherein the folding device 12 comprises at least two longitudinal folding devices 13 and 14 positioned behind one another for the longitudinal folding of the printed substrate web and a severing device 15 positioned downstream of the longitudinal devices 13 and 14, in which individual signatures can be severed from the printed substrate web 11. The signatures severed from the substrate web 11 can be accelerated via an acceleration device 16 in order to feed the same to a device 17 for forming book blocks according to the invention with a defined spacing. In the device 17 according to the invention, book blocks 18 can be formed from collected signatures, wherein details of the device 17 for forming book blocks according to the invention are discussed in the following.

The device 17 according to the invention serves for forming book blocks 18 from signatures which are printed in a printing press located upstream or separated and if appropriate folded signatures unwound from an unwinding device located upstream, wherein with the help of the device 17 according to the invention both glued as well as non-glued book blocks can be formed.

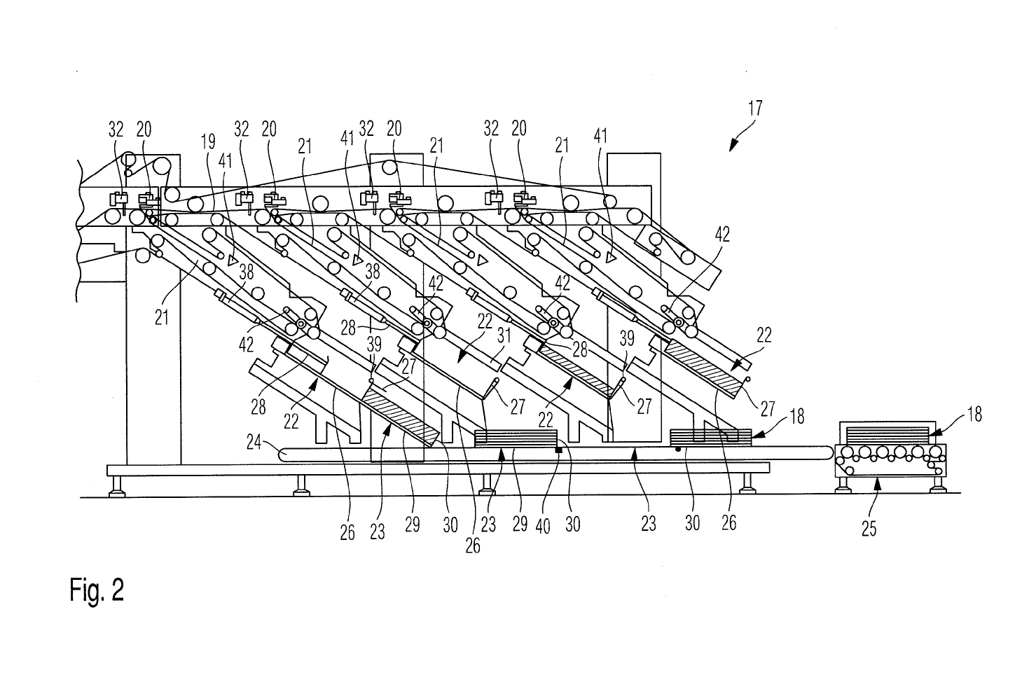

The device 17 according to the invention comprises a first conveying device 19, which in the shown exemplary embodiment is designed as a belt conveyor, wherein the first conveying device 19 accepts the separated and if appropriate folded signatures printed in a printing press 10 located upstream. According to FIG. 2, the first conveying device 19 in this case runs in the horizontal direction and transports the printed, separated and if appropriate folded signatures in the horizontal direction.

The device 17 according to the invention furthermore comprises at least one signature switch 20, which is assigned to the first conveying device 19. In the shown preferred exemplary embodiment, the first conveying device 19 is assigned a total of four signature switches 20, via which a signature can be conveyed in different directions.

The device according to the invention furthermore comprises multiple second conveying devices 21, which in turn are designed as belt conveyors. Each of the signature conveyed by the first conveying device 19 can each be supplied to one of the multiple second conveying devices 21 dependent on the switching position of the signature switches 20.

Each second conveying device 21 is assigned a book block former 22. Each of the book block formers 22 can be supplied with the signatures belonging to the same book block 18 dependent on the switching position of the signature switches 20 via the second conveying device 21 interacting with the respective book block former 22.

A placer 23 each interacts with each book block former 22. The book block formed in the respective book block former 22 can be accepted by the respective placer 23 following the release through the respective book block former 22, in order to place the book block onto a third conveying device 24 with the help of the respective placer 23, via which the blocks 18 can be transported in the direction of a delivery device 25.

The third conveying device 24 runs below the first conveying device 19 in the horizontal direction and transports the formed book blocks 18 in the horizontal direction in the direction of the delivery device 25.

The device 17 for forming book blocks according to the invention accordingly comprises multiple different conveying devices 19, 21 and 24, namely the first conveying device 19, which serves for the horizontal transport of the signatures, the third conveying device 24, which serves for the horizontal transport of the book blocks 18 and the second conveying devices 21, which serve for the transport of the signatures to the book block formers 22 dependent on the position of the signature switches 20, wherein the second conveying devices 21 run obliquely from the top down between the first conveying device 19 and the book block formers 22, wherein the book block formers 22 are positioned below the first conveying device 19 and above the third conveying device 24.

The second conveying devices 21 in this case are designed in such a manner that on the same the signatures can be shingled up into a shingle stream before the introduction into the respective book block former 22. This can be realized in that the second conveying devices 21 have a region upstream of the book block formers 22 which slows down the signatures. In FIG. 2, each second conveying device 21 is assigned a shingle former 42. Shingling can be effected with a fixed or variable overlap.

The book block formers 22 are format variable. On the same, signatures with a defined format width and a defined format height can be collected into a book block 18 with a defined format thickness, namely format-variably with respect to the format width and/or format height and/or format thickness.

Each book block former 22 comprises an obliquely running support 26 and a front stop 27, wherein the respective stop 27 can be transferred between a first position, in which on the same the signatures belonging to a book block can be collected, and a second position, in which the same releases a book block formed in the book block former 22. Thus, it is evident from FIG. 2, that each stop 27 can be pivoted about an axis 39, in order to be transferred from the first position into the second position and vice versa from the second position into the first position.

With each book block former 22, a book block conveyor 28 furthermore interacts, which in the exemplary embodiment of FIG. 2 is designed as a pusher. In particular when the stop 27 of the respective book block former 22 is pivoted into the second position and releases the book block 18 formed in the book block former 22, the respective book block 18 can be pushed out of the respective book block former 22 via the book block conveyor 28 assigned to the respective book block former 22 and fed to the placer 23 interacting with the respective book block former 22.

As already explained, the book block conveyor 28 in the exemplary embodiment of FIG. 2 is designed as a pusher, which grips the book block 18 formed in the respective book block former 22 by a rear edge pushing it out of the respective book block former 22 in the direction of the placer 23 interacting with the respective book block former 22 in particular when the stop 27 of the book block former 22 is pivoted into the second position and releases the book block 18 on the front end located opposite the rear end.

Each placer 23 can be transferred between a first position, in which the same, starting out from the book block former 22 interacting with the same, can be supplied with a book block 18, and a second position, in which by the same a book block 18 can be placed onto the third conveying device 24. According to FIG. 2, each placer 23 can be pivoted about an axis 40, wherein each placer 23 comprises a pivotable support 29 and a stop 30 that can be pivoted together with the support 29.

In particular when the respective placer 23 is transferred into the first position, the supports 26 and 29 of book block former 22 and placer 23 are in alignment and the stop 30 serves as stop for pushing the book block 18 out of the book block former 22 into the placer 23. In particular when the respective placer 23 is pivoted into the second position the stop 30 of the same can be pivoted relative to the support 29 of the same so that support 30 and support 29 are then located in a common plane in order to release the respective book block 18 in this way, so that the same can be transported by the third conveying device 24 in the direction of the delivery device 25.

The stop 27 of the respective book block former 22 can be exclusively transferred from the first position into the second position in particular when the placer 23 interacting with the respective book block former 22 is transferred into the first position.

Each book block former 22 is assigned a pressing device 31. With the help of the pressing devices 31, the book blocks 18 formed in the book block formers 22 can be compressed and thus compacted at least in sections, namely prior to the pushing-out of the book block 18 from the book block formers 22 and thus prior to the pushing in of the same into the placers 23.

As explained above, both non-glued or non-bonded as well as glued or bonded book blocks 18 can be formed with the help of the device 17 according to the invention. For forming glued book blocks 18, the device 17 comprises at least one glue application device 41, with the help of which glue can be applied onto the substrate or the signatures, which are to be combined into a book block 18 in the region of the respective book block former 22.

Accordingly, each glue application device 41 is arranged upstream of the respective book block former 22, namely preferentially downstream of the respective signature switch 20. In contrast with this it is also possible to arrange the glue application devices upstream of the respective signature switch 20. In FIG. 2, stopper monitors 32 are shown upstream of the respective signature switch 20.

The glue or adhesive is preferentially applied via the respective adhesive application device 41 from the top or from the bottom onto the signatures preferentially on one side. Here, adhesive is then applied onto each signature of a book block 18, with the exception of the last or uppermost signature of the respective book block. In contrast with this it is also possible to arrange the adhesive application devices in such a manner that these apply adhesive onto the signatures of a book block to be formed from below. In this case, glue is applied onto each signature except for the first or lowermost signature of a book block 18 from below.

In forming glued book blocks 18, the pressing devices 31 are advantageous in order to compress the signatures provided with adhesive at least in the region of the adhesive application before the pushing-out of the respective book block former 22.

The production of book blocks 18 with the device 17 shown in FIG. 2 accordingly is effected in such a manner that with the help of the first conveying device 19 individual signatures are conveyed in the horizontal direction, namely in the direction of the signature switches 20. Dependent on the switching position of the signature switches 20, the signatures are diverted into the region of one of the obliquely running second conveying devices 21 and thus fed to one of the book block formers 22, wherein on the signature switches 20 all signatures belonging to a book block 18 are guided into the region of the same book block former 22. Following signatures of the next book block are then conveyed in the direction of the next signature switch 20 and thus in the direction of the next book block former 22. When forming glued book blocks 18, adhesive or glue is applied onto the signatures. The signatures are shingled up in the region of the second conveying devices 21. A shingled stream of shingled signatures reaches the region of the respective book block former 22, wherein the signatures subject to forming the book block come to lie against a stop both at their front ends and also at their rear ends, namely in the region of the front end against the pivotable stop 27 and in the region of the rear end against the book block conveyor 28. As soon as all signatures of a book block have been collected in the book block former 22, the book block is preferentially compressed via the respective pressing device 31. The placer 23 interacting with the respective book block former 22 is pivoted upwards so that its support 29 is in alignment with the support 26 of the respective book block former 22. Following this, the stop 27 of the respective book block former 22 can be pivoted subject to releasing the respective book block 18, wherein the respective book block conveyor 28 then pushes the book block 18 out of the respective book block former 22, pushing it into the respective placer 23, wherein in the process the respective book block 18 comes to lie against the stop 30 of the respective placer 23. Following this, the placer 23 pivots downwards in order to subsequently pivot the stop 30 of the same and release the respective book block 18 for transport by the third conveying device 24. The above procedure takes place in alternating cycles between the different book block formers 22 and placers 23 of the device 17.

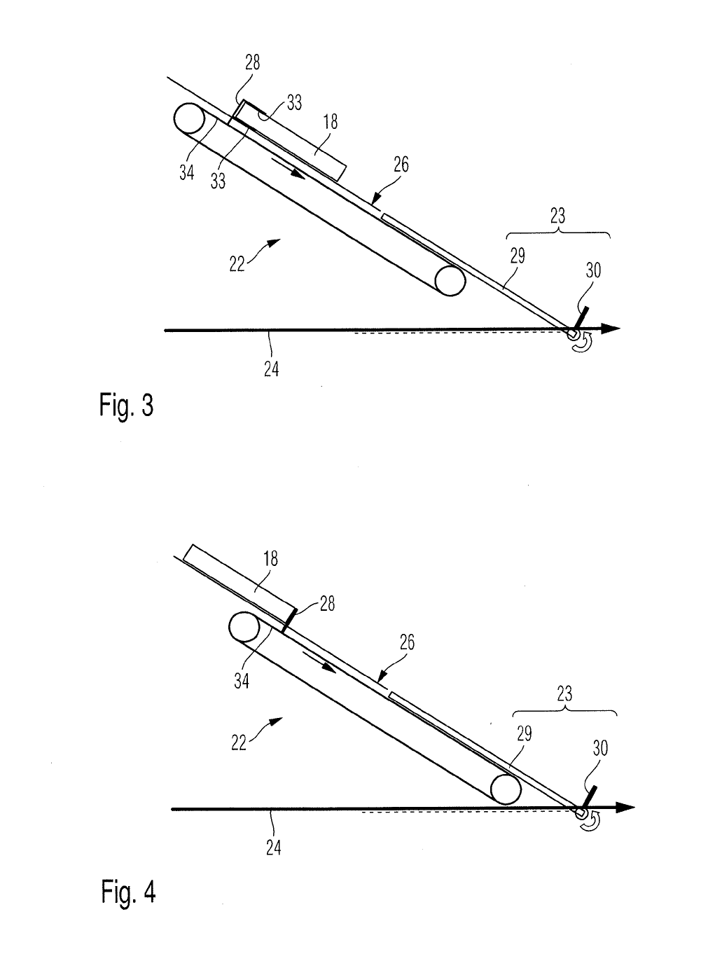

In the exemplary embodiment of FIG. 2, the book block conveyors 28 are designed as pushers, which push a book block 18 via its rear edge or its rear end out of the respective book block former 22 and into the respective placer 23. FIGS. 3 to 5 show versions of the device 17 according to the invention in the region of the book block conveyor interacting with the respective book block former 22 and the respective placer 23.

In the exemplary embodiment of FIG. 3, the book block conveyor 28 is also designed as a pusher, which takes the respective book block 18 to be conveyed out of the respective book block former 22 by an in-transport direction rear end, wherein in the exemplary embodiment of FIG. 3 the book block conveyor 28 clamps the book block to be transported at the rear end. The book block conveyor 28 designed as a pusher accordingly comprises clamping beams 33, which come to lie against the book block 18 at the top and bottom and clamp and fix the same in the region of its rear end during the pushing-out of the book block former 22.

A further difference of the book block conveyor 28 of FIG. 3 compared with the book block conveyors 28 shown in FIG. 2 consists in that in FIG. 3 the actual book block conveyor 28 is mounted on a belt conveyor 34 and not, as shown in FIG. 2, is actuated via a linearly displaceable piston 38.

FIG. 4 shows a book block conveyor 28, which just like in FIG. 3 is received on a belt conveyor 34 and moved via the belt conveyor 34, wherein the book block conveyor 28 of FIG. 4 is designed as a stop, against which the book block 18 formed in the respective book block former 22 comes to lie with a front end. Here it can be provided to clamp and fix the book block 18 to be conveyed in the region of its front end via a clamping device of the book block conveyor 28.

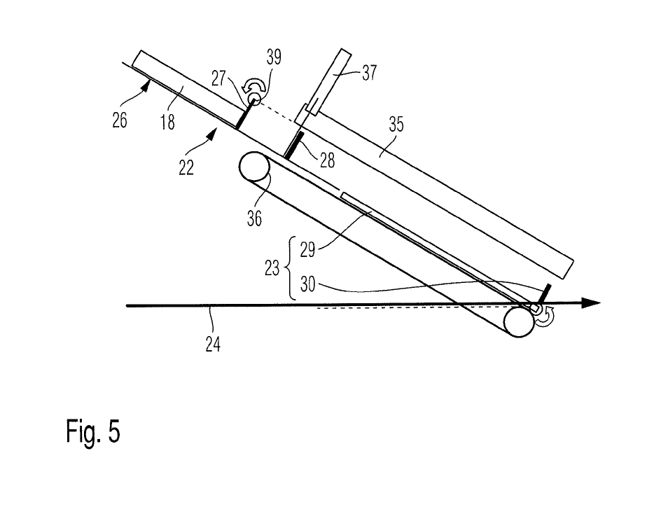

A further version of a book block conveyor 28 is shown by FIG. 5, wherein in FIG. 5 the book block conveyor 28 can come to lie both at the rear end and also at the front end of the book block 18 to be pushed out. Preferentially, the movement of the book block 18 formed in the book block former 22 is effected in FIG. 5 in such a manner that following the release of the book block 18 in the book block former 22 through pivoting of the stop 27 the book block 18 under the effect of gravity slides downwards and in the process comes to lie against the book block conveyor 28 with its front end. The book block conveyor 28 which serves as stop for the front end of the book block 18 can then be displaced downwards with the help of a piston 35, in particular of a pneumatic piston, wherein the book block 18 then reaches the region of a belt conveyor 36, via which the book block 18 can be supplied to the placer 23. By way of a further piston 37, the book block conveyor 28 which serves as stop can be retracted in order to release the book block 18, so that the same ultimately can come to lie against the stop 30 of the placer 23.

In place of the belt conveyors, other conveying systems can also be employed, for example chain conveyors, the thong conveyors or gripper systems.

Both in the region of the book block formers 22 and also in the region of the placers 23 does the respective book block 18 lie against a stop 27 and 30 respectively with its front end, wherein the stops 27, 30 can be embodied as rakes.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for forming book blocks, comprising:
a first conveying device, wherein the first conveying device accepts signatures printed in a printing press located upstream;
a plurality of signature switches assigned to the first conveying device;
a plurality of second conveying devices;
wherein a signature conveyed by the first conveying device is supplyable to one of the plurality of second conveying devices dependent on a position of the plurality of signature switches;
a plurality of book block formers, wherein each of the plurality of second conveying devices is assigned a respective one of the plurality of book block formers and wherein each of the plurality of book block formers are supplyable with signatures belonging to a same book block via the respective second conveying device;
a plurality of placers, wherein each of the plurality of book block formers is assigned a respective one of the plurality of placers, wherein each of the plurality of placers accepts book blocks formed in the respective book block former following release by the respective book block former; and
a third conveying device, wherein book blocks formed in the plurality of book block formers are placeable on the third conveying device by the plurality of placers and wherein the third conveying device feeds the book blocks formed to a delivery device.

2. The device according to claim 1, wherein the first conveying device runs horizontally and transports printed, separated and folded signatures in a horizontal direction.

3. The device according to claim 2, wherein the third conveying device runs horizontally below the first conveying device and transports the book blocks formed in the horizontal direction.

4. The device according to claim 3, wherein the plurality of second conveying devices each run obliquely from a top down between the first conveying device and the plurality of book block formers.

5. The device according to claim 4, wherein signatures are shingled up on the plurality of second conveying devices before being supplied to the respective book block former.

6. The device according to claim 1, wherein the plurality of book block formers are format-variable with respect to a book block length and/or a book block width and/or a book block thickness.

7. The device according to claim 1, wherein each of the plurality of book block formers includes a stop which is transferable between a first position in which signatures belonging to a book block are collectable and a second position in which a book block formed in the book block former is releasable, and wherein each of the plurality of book block formers is assigned a book block conveyor which, in the second position of the stop, feeds the book block formed in the book block former to the respective placer.

8. The device according to claim 7, wherein each of the book block conveyors is a pusher which pushes the book block formed in the respective book block former by a rear end of the book block formed out of the respective book block former in a direction of the respective placer.

9. The device according to claim 7, wherein each of the book block conveyors is a stop against which the book block formed in the respective book block former lies with a front end.

10. The device according to claim 8, wherein each of the book block conveyors clamps the book block formed at a rear end or at a front end of the book block formed.

11. The device according to claim 1, wherein each of the plurality of book block formers includes a pressing device, wherein each book block formed in the respective book block former is compressible at least in sections by the pressing device.

12. The device according to claim 1, wherein each of the plurality of placers is transferrable between a first position in which a book block formed in the respective book block former is supplyable to the respective placer and a second position in which the book block formed is placeable onto the third conveying device.

13. The device according to claim 7, wherein each of the plurality of placers is transferrable between a first position in which a book block formed in the respective book block former is supplyable to the respective placer and a second position in which the book block formed is placeable onto the third conveying device and wherein the stop is transferable from the first position into the second position exclusively when the respective placer is transferred into the first position.

14. The device according to claim 1, further comprising an adhesive application device, wherein adhesive is applyable onto signatures to be collected into a book block by the adhesive application device.

15. The device according to claim 14, wherein the adhesive application device is arranged upstream of the plurality of book block formers.
